(19) United States
(12) Patent Application Publication
(10) Pub. No.: US 2011/0029892 A1
(43) Pub. Date: Feb. 3, 2011

(54) System and Method For Integrating Advanced Multimedia Features Within An Instant Messaging Environment

(75) Inventors: Kevin Kurtz, Bethel, CT (US); Pak-Kei Mak, Taikoo Shing (HK); Scott Werndorfer, Brookfield, CT (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: CERULEAN STUDIOS, Brookfield, CT (US)

(21) Appl. No.: 12/904,011

(22) Filed: Oct. 13, 2010

Related U.S. Application Data
(62) Division of application No. 10/966,420, filed on Oct. 14, 2004, now abandoned.

(51) Int. Cl. G06F 3/048; G06F 15/16

(52) U.S. Cl. 715/752

(57) ABSTRACT

An instant messaging graphical user interface (“GUI”) is described comprising: a text entry region in which a user may enter instant messages; an IM conversation window in which a complete IM conversation between the user and a selected contact appears; a video window for displaying real time video of the user and/or the contact during an IM session; and a plurality of user-selectable personal video recorder (“PVR”) controls for performing a respective plurality of PVR functions on the video displayed within the video window, the PVR functions including record, pause, and rewind for recording, pausing, and rewinding the video, respectively.

### RELATED APPLICATIONS

This application is a divisional of U.S. patent application Ser. No. 10/966,420, Filed Oct. 14, 2004 entitled “SYSTEM AND METHOD FOR INTEGRATING ADVANCED MULTIMEDIA FEATURES WITHIN AN INSTANT MESSAGING ENVIRONMENT,” and related to applications entitled “SYSTEM AND METHOD FOR MANAGING CONTACTS IN AN INSTANT MESSAGING ENVIRONMENT,” Ser. No. 10/209,586, Filed Jul. 29, 2002; and APPARATUS AND METHOD FOR GENERATING AUDIO AND GRAPHICAL ANIMATIONS IN AN INSTANT MESSAGING ENVIRONMENT Ser. No. 10/211,223, Filed Jul. 29, 2002, which are incorporated herein by reference.

### BACKGROUND

1. Field of the Invention

The invention relates generally to the field of data communication systems. More particularly, the invention relates to a system and method for integrating advanced multimedia (e.g., audio/video) features within an instant messaging client.

2. Description of the Related Art

Instant messaging systems provide for live, text-based chat sessions between two or more users. Unlike e-mail, instant messaging requires that all parties be online at the same time. AOL's Instant Messenger (“AIM”), Microsoft Network Messenger Service (“MSNMS®”), ICQ® and Yahoo! Messenger® are the major instant messaging services.

Instant messaging clients allows users to maintain a list of contacts, often referred to as a “buddy list” or “contact list.” A user can send instant messages to any of the people in the user's list, as long as those people are online. Sending a message opens up a small window where the user and the user's buddies can type in messages that both can see.

Most of the popular instant messaging programs provide a variety of supplemental features including, for example, Web links (the ability to share links to Websites); image sharing (the ability to view images stored on a buddy's computer; sound sharing (the ability transmit sounds to a buddy); file sharing (the ability to transmit files to a buddy); audio communication (the ability to use the Internet instead of a phone to actually talk with buddies); and information streaming (streaming of real-time or near-real-time information such as stock quotes and news headlines).

Some of the basic principles associated with an instant messaging session will now be described with respect to FIG. 1. In order to establish an instant messaging session, client computers 102 and 104 operated by end users, must initially connect over a network (e.g., the Internet) to an instant messaging service 100. The client computers 102 and 104 typically establish a connection via a dial up line, cable modem connection or digital subscriber line (“DSL”). Alternatively, the client computers 102 or 104 may be connected to the Internet via a local area network (“LAN”) gateway.

In order to communicate with the specified instant messaging service 100, proprietary instant messaging client software must initially be installed on the client computers 102 and 104. For example, if the instant messaging service 100 is AIM, then AOL's proprietary instant messaging client software must be installed. The client software allows the client computers 102 and 104 to communicate with the AIM server using AOL's proprietary instant messaging protocol.

Similarly, other instant messaging services, such as IM service 108, will require different client software installed on client computers 106 and 110. For example, Yahoo's proprietary IM software, which includes built-in support for Yahoo's proprietary IM protocol, must be installed on any client computer that uses Yahoo's IM service. Moreover, the client IM software and associated IM protocols required by each service 100, 108 are not compatible. Client software designed for one service may not be used to connect to a different service.

Once the IM client software is installed, to establish an IM session, the client sends the IM service connection information associated with the client computer (e.g., IP address and port number). The IM service creates a temporary file that contains the connection information for the user and the contacts in the user's buddy list. It then checks to see if any of the contacts in the buddy list are currently logged in.

If the service locates any contacts logged in, it sends the connection information for those contacts back to the client. The IM service also sends the user's connection information to the contacts in the buddy list that are signed on. When the client receives the connection information for a contact in the buddy list, it changes the “status” of that person to “Online.” The user may then click on a name of any contact in the buddy list who is online, opening an IM window in which the user may enter an instant message.

Once the users have signed on to the IM service, all subsequent communication may occur directly between the two clients, as indicated by the “direct link” between clients 102 and 104, and clients 106 and 110. However, in some circumstances, IM communication must continue to occur through the instant messaging service 100. For example, if client 104 is behind a firewall, client 102 may not be permitted to establish an IM session with client 104 directly.

When the user goes “offline” the client sends a message to the IM server to terminate the session. The server then sends a message to the clients of each contact in the user's buddy list who are currently online to indicate that the user has logged off. Finally, the IM server deletes the temporary file that contained the connection information for the client(s).

### SUMMARY

An instant messaging graphical user interface (“GUI”) is described comprising: a text entry region in which a user may enter instant messages; an IM conversation window in which a complete IM conversation between the user and a selected contact appears; a video window for displaying real time video of the user and/or the contact during an IM session; and a plurality of user-selectable personal video recorder (“PVR”) controls for performing a respective plurality of PVR functions on the video displayed within the video window, the PVR functions including record, pause, and rewind for recording, pausing, and rewinding the video, respectively.

### BRIEF DESCRIPTION OF THE DRAWINGS

A better understanding of the present invention can be obtained from the following detailed description in conjunction with the following drawings, in which:

FIG. 1 illustrates the basic principles associated with current instant messaging systems.

FIG. 2 illustrates an instant messaging client architecture according to one embodiment of the invention.

FIG. 3 illustrates an instant messaging GUI according to one embodiment of the invention.

FIG. 4 illustrates a service-based menu according to one embodiment of the invention.

FIG. 5 illustrates a connection manager according to one embodiment of the invention.

FIG. 6 illustrates a text analysis architecture employed in one embodiment of the invention.

FIG. 7 illustrates an instant messaging user interface employed in one embodiment of the invention.

FIG. 8 illustrates an informational window generated by one embodiment of the invention.

FIG. 9 illustrates an option menu generated in one embodiment of the invention.

FIGS. 10-12c illustrate one embodiment of an instant messaging user interface employing advanced multimedia features.

FIGS. 13-18 illustrates embodiments of an activity history interface and related activity history processing.

FIG. 19 illustrates a GUI for adding, activating and removing plugins according to one embodiment of the invention.

FIG. 20 illustrates one embodiment of a GUI for activating, deactivating and removing plugins.

FIG. 21 illustrates a tabbed container window implemented in one embodiment of the invention.

FIG. 22 illustrates one embodiment of a graphical user interface for managing audio/video sequences.

FIG. 23 illustrates an exemplary GUI for managing emotiblips.

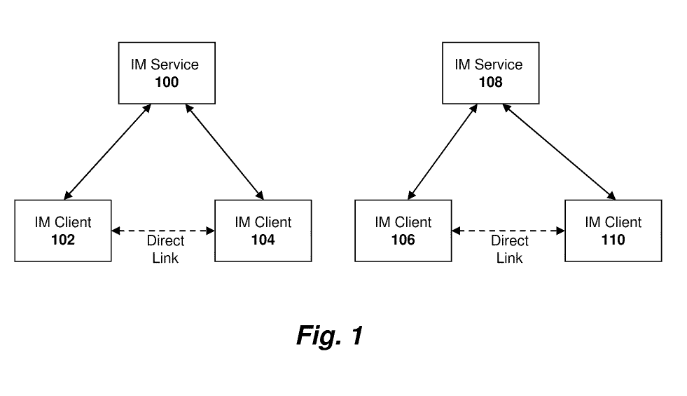

### DETAILED DESCRIPTION OF PREFERRED EMBODIMENTS

Described below is a system and method for instant messing. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Note that in this detailed description, references to “one embodiment” or “an embodiment” mean that the feature being referred to is included in at least one embodiment of the invention. Moreover, separate references to “one embodiment” in this description do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

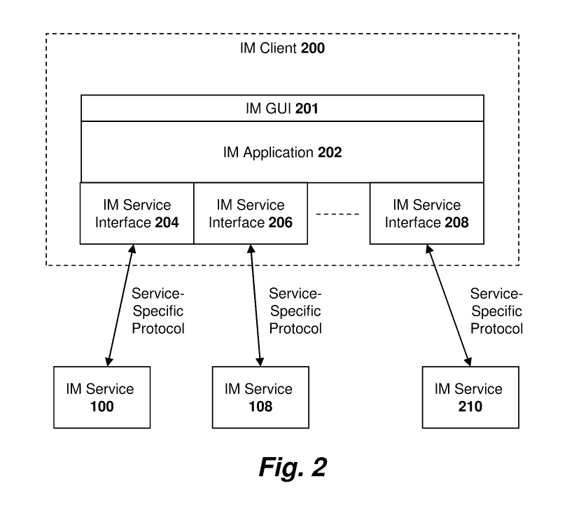

The assignee of the present application designed a universal instant messaging client having features described in the related patent applications mentioned above (filed on Jul. 29, 2002). To address the lack of interoperability between different IM services, the universal instant messaging client is interoperable with each of the different IM services. Referring to FIG. 2, the IM client platform 200 is comprised generally if an IM application portion 202, which contains standard IM functions used by each IM service 100, 108, 210 (e.g., a buddy list, user-defined online/offline parameters, and other universal IM features). Users interact with the IM application 202 via an IM graphical user interface (“GUI”) 201, various features of which are described below. Finally, in order to provide interoperability with the different, normally incompatible, IM services, an IM service interface module 204, 206, 208 is provided for each IM service 100, 108, 210, respectively. The IM service interface modules 204, 206, 208 provide service-specific features and communicate with the respective IM services 100, 108, 210 using the IM protocol required by that service. For example, if IM service 100 is AOL, then IM service interface 204 communicates using AOL's proprietary instant messaging protocol. The various service-specific protocols are employed by the IM client 200 transparently to the end user. In sum, the architecture illustrated in FIG. 2 allows a user to access accounts on different instant messaging services using a unified IM application 202 and a consistent graphical user interface 201.

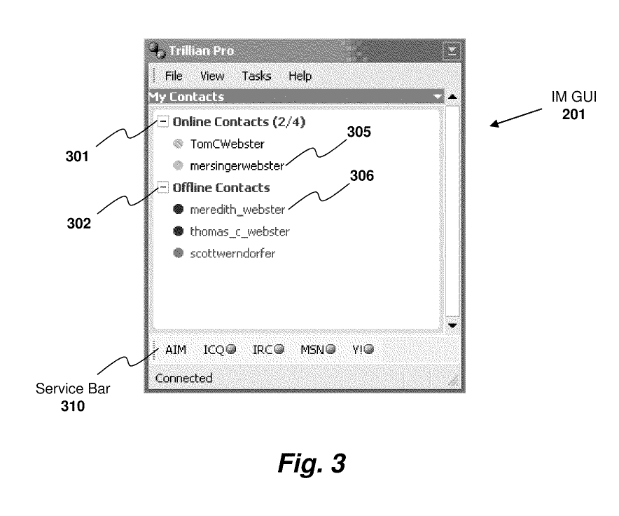

One embodiment of the instant messaging GUI 201 is illustrated in FIG. 3. The GUI 201 is comprised of a buddy list which, like other IM buddy lists, is separated into a list of online contacts 301 and a list of offline contacts 302. Unlike prior buddy lists, however, the buddy lists illustrated in FIG. 3 may include contacts from various different IM services. For example, the contact entries “MerSingerWebster” 305 and “Meredith_Webster” 306 may be screen names for the same individual on different IM services (e.g., AOL and Yahoo). In the particular example shown in FIG. 3, the individual is registered as online on one account (MerSingerWebster 305) and offline for the other account (Meredith_Webster 306).

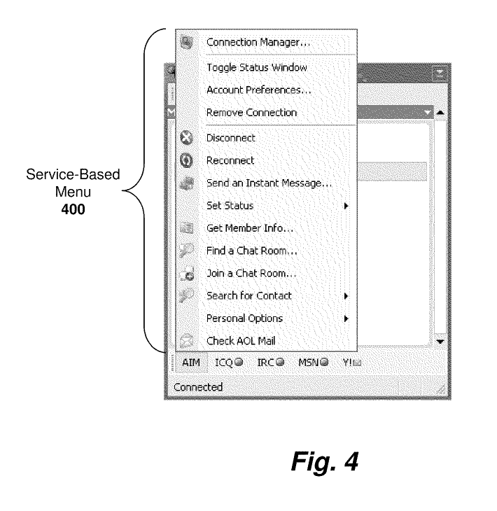

In order to coordinate among the various IM services, a service bar 310 is provided which includes a set of graphical buttons representing each of the different services. The user may connect to a particular service and/or access/modify the features provided by that service by selecting the button corresponding to the service. By way of example, in FIG. 4, the user has selected the AIM button, bringing up a service-based menu 400 which includes settings/preferences for AOL's IM service. The options available on the menu may change from one button to the next, based on the options available for each service.

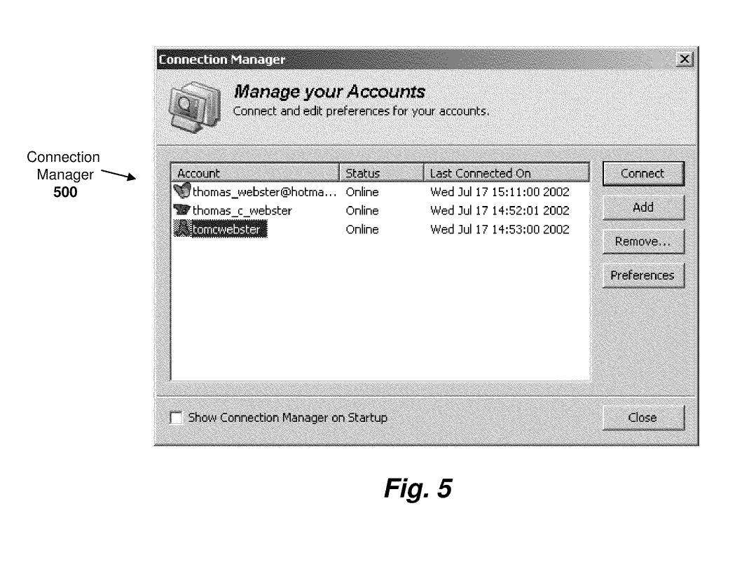

The user may connect to multiple services at once, using one or more different screen names. However, in one embodiment, if the user is not logged in to a particular service, the only option which will be provided via the service bar is the “connection manager” option (shown at the top of the menu in FIG. 4). Selecting this option will bring up a connection manager window 500, such as that shown in FIG. 5, which provides a list of all services on which the user has an account. In the particular connection manager window 500 illustrated in FIG. 5, the user has set up accounts for Microsoft, Yahoo! and AOL. From the connection manager window 500, the user may connect to the various IM accounts, add new accounts, delete accounts, and modify preferences for each account.

One embodiment of the GUI 201 provides the user with the option to “globally connect” or “globally disconnect” from each service on which the user has an account, thereby streamlining the process of connecting/disconnecting to multiple services. Similarly, one embodiment provides the user with the option to globally set his/her online status to “globally away” or “globally back.” Each of the global functions may be provided within the IM application 202. The IM service interfaces 204, 206, and 208 may translate the global functions to service-specific functions, interpretable by each individual service 100, 108, and 210, respectively. Global functions may be provided as menu entries within the GUI menu structure (e.g., File, and/or may be triggered via certain specified hotkeys (e.g., CTRL+D=global disconnect, . . . etc).

The embodiments of the invention described below provide a variety of new instant messaging features. These features may be used alone, or in combination with the features of the instant messaging client described in the related applications.

### Input Analysis and Supplemental Content Processing

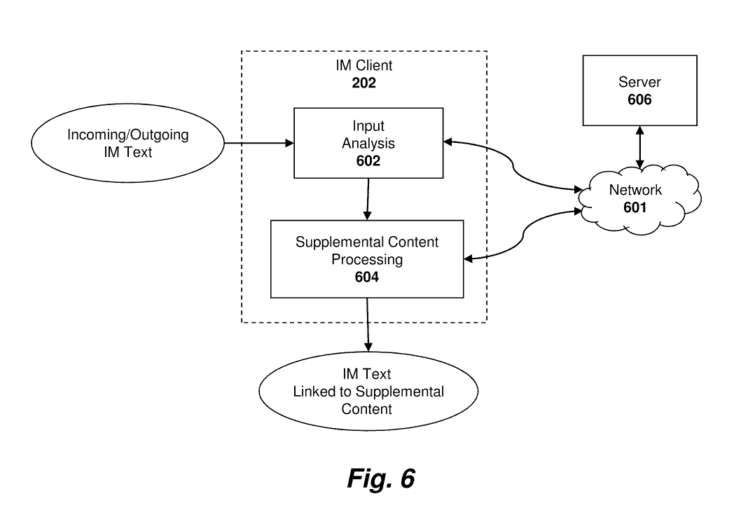

In one embodiment of the invention, the instant messaging client 200 is configured to analyze the text entered by the sender and/or receiver during an instant messaging session and to perform one or more designated actions in response to its analysis. Specifically, FIG. 6 illustrates an IM client architecture which includes an input analysis module 602 for analyzing the text entered by the users involved in an IM session, and a supplemental content processing module 604 for linking supplemental content to the text in response to the analysis. As indicated in FIG. 6, in one embodiment, the IM client 200 receives the supplemental content (and the information linking the supplemental content to certain text) from a remote server 606. The server 606 may transmit the supplemental content to the IM client dynamically, during the course of each instant messaging session. Alternatively, or in addition, the server 606 may transmit the supplemental content to the IM client 202 prior to the initiation of each instant messaging session. The server 606 may be the same server which provides instant messaging service, or may be a different server.

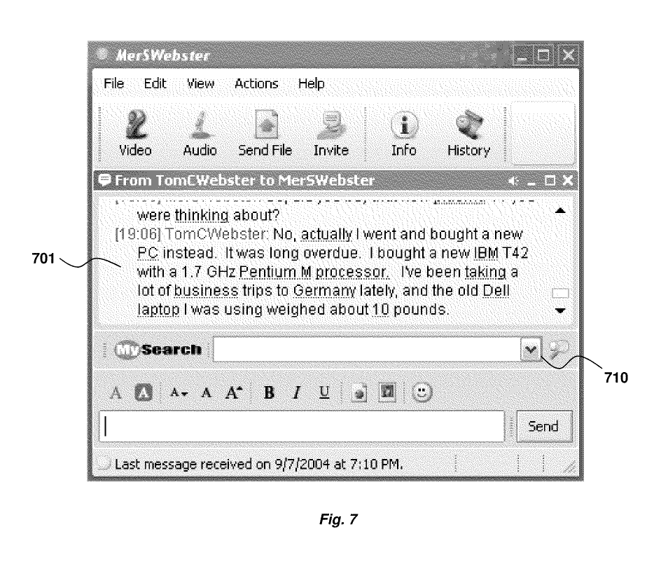

Various types of supplemental content may be transmitted to the IM client 200 and various techniques may be employed at the IM client 200 notify users of the existence of the supplemental content. FIG. 7 illustrates one embodiment of a graphical user interface (“GUI”) which includes a text entry region 702 in which the user may enter instant messages, and an IM conversation window 701 in which the complete IM conversation between the user and the selected contact appears. Text within the IM conversation window 701 is underlined to indicate the existence of supplemental content. Specifically, the terms “that,” “actually,” “PC,” “IBM,” “Pentium M,” “processor,” “business,” “Germany,” “Dell,” “laptop” and “10” are underlined.

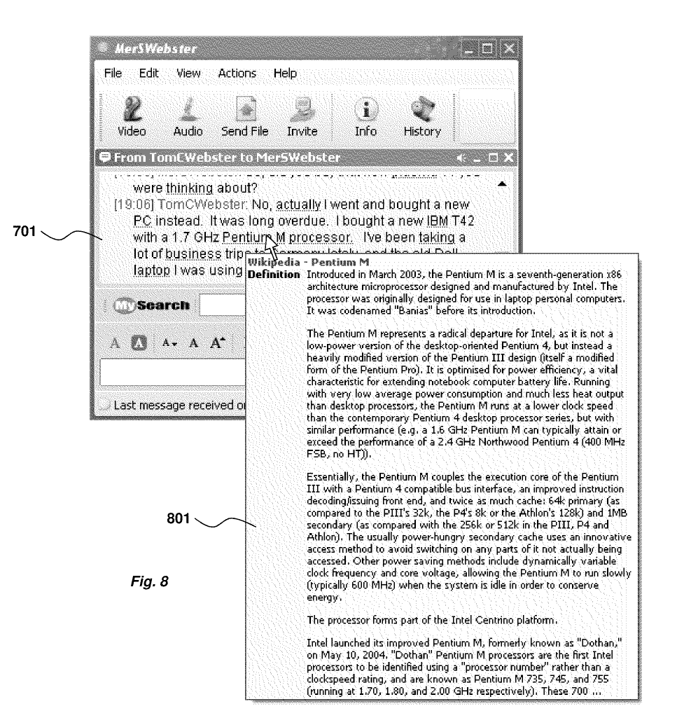

The user may then access the supplemental content in a variety of ways. As shown in FIG. 8, in one embodiment, the user may simply “mouse over” an underlined term (i.e., move the mouse pointer over the term without clicking a button), to reveal the supplemental content. In the specific example shown in FIG. 8, the user has moused over the term “Pentium M.” In response, the IM client 200 generates an informational window 801 containing information related to the Pentium M processor. In the particular example shown in FIG. 8, the information includes a definition and history of the Pentium M processor.

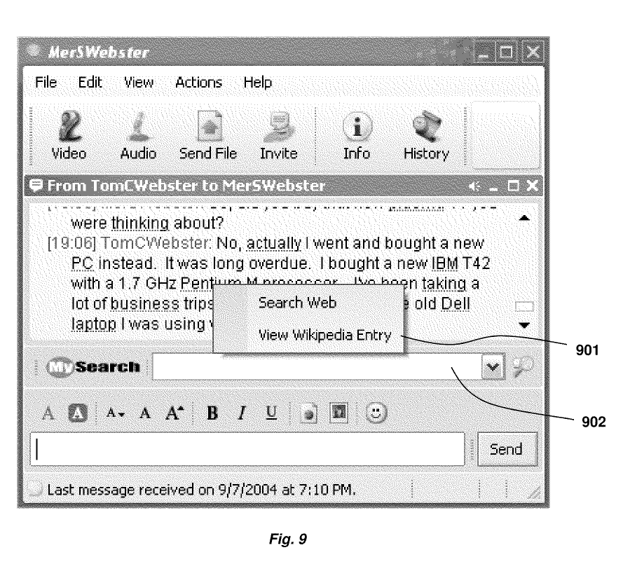

In one embodiment, illustrated in FIG. 9, clicking on the underlined item generates a menu 901 of options related to the underlined item. In FIG. 9, these include an option to search the Web for the term using an online search engine (e.g., Yahoo, Google, . . . etc) and an option to view an encyclopedia entry for the term (in this case, using the Wikipedia encyclopedia, currently located at en.wikipedia.org).

In one embodiment, the input analysis module 602 does not merely identify individual words within the IM text but also identifies the context in which the words are used. To do so, the input analysis module 602 evaluates other terms used prior to or following the current term (e.g., within the same sentence, paragraph, time period, . . . etc) and identifies a correlation between the terms which corresponds to a particular context. For example, the term “plasma” may be used in a variety of contexts including plasma televisions, plasma etching and deposition (used in semiconductor processing), medical uses for plasma (the fluid portion of blood), and plasma gas (the charged particles found the atmospheres of stars or metal).

Thus, by analyzing the other terms surrounding the term “plasma,” the input analysis module 602 identifies the correct context in which the term “plasma” is used and provides the context to the content processing module 604. For example, if “television” or “TV” is located within the same sentence as “plasma” then the input analysis module 602 may determine that the IM users are discussing plasma TVs. Using this information, the supplemental content processing module 604 will then identify/retrieve supplemental content related to plasma TVs (e.g., current prices of plasma TVs, a link to a Fry's Electronics sale related to plasma TVs, a link to an Ebay auction for a plasma TV . . . etc). The IM client 200 then underlines (or otherwise highlights) the word “plasma” within the IM GUI 201, indicating that supplemental content is available.

The IM client 200 may highlight text within the GUI in a variety of ways (rather than merely underlining the text). For example, the IM client 200 may bold or italicize the text, and/or may change the color of the text, or of the foreground of the text. Moreover, in one embodiment the IM client 200 highlights text differently for different types of supplemental content. For example, the IM client 200 may underline text associated with advertisements using a red underline and underline text associated with all other types of content (e.g., encyclopedia entries) in green. Multiple highlights may be applied to the same text to indicate multiple types of content associated with the text (e.g., red and green).

Once again, the foregoing examples are used merely for the purpose of illustration. The underlying principles of the invention are not limited to any specific mechanism for highlighting text or for providing supplemental content to the end user.

Various types of supplemental content may be retrieved and linked to text as described above including, but not limited to, standard definitions or encyclopedia entries, advertisements (e.g., provided by an advertisement server), and links to related websites. In one embodiment, if a screen name of another user is entered as text, then the supplemental content will include a link to start an instant messaging session with that user (e.g., via a mouse click on the user's screen name). Various other types of supplemental content may be retrieved and linked to text while still complying with the underlying principles of the invention.

In addition to detecting text strings and the context in which the text strings are used, in one embodiment the input analysis module 602 identifies certain data formats within the IM text. For example, the input analysis module 602 may identify telephone numbers and/or addresses based on the format in which the data is presented (e.g., 952 Johnston Ave, San Jose, Calif. may be identified based on the term Ave, San Jose and/or CA). In response, the input analysis module will identify the data format to the supplemental content processing module 604 which will then retrieve relevant supplemental content. For example, if the data format is an address, then the supplemental content processing module 604 may retrieve a map showing the location of the address, or an advertisement of a business located near the address.

In addition, the IM client illustrated in FIGS. 7-9 includes a search field 710 integrated directly within the IM chat window in which the user may enter one or more search terms. In response, the IM client 200 transmits the search terms to a search engine which then provides the user with search results. In one embodiment, the search results are provided as a series of links within a Web browser such as Internet Explorer (e.g., as if the user had searched directly from within the Web browser).

### Integrated Multimedia Features

Current instant messaging clients support real time audio/video sessions between computers equipped with a video camera (e.g., such as the Logitech Quickcam Zoom) and microphone. One embodiment of the invention provides support for audio/video sessions with a variety of advanced user-configurable options and features.

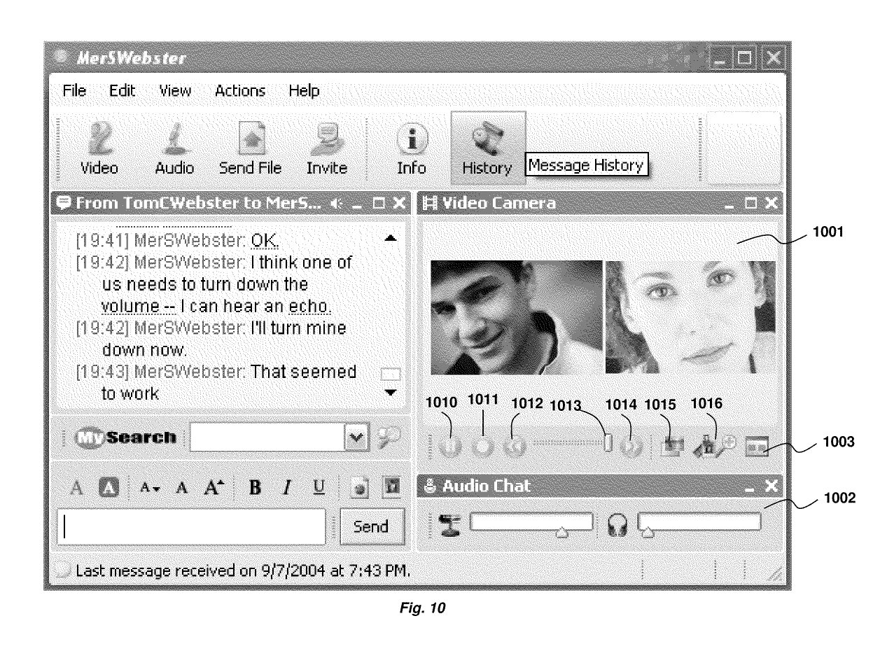

FIG. 10 illustrates one embodiment of the instant messaging GUI 201 which includes a video window 1001 for displaying and controlling video during an IM session and a separate audio window 1002 for controlling audio during the IM session. As illustrated, in one embodiment, the video window may be configured to display two full video images: one of the local user, and one of the buddy with whom the user is communicating. By selecting a designated button 1003 within the GUI, the user may toggle between dual video images (as shown), full video of the user's chat buddy, and picture in picture (e.g., where a smaller video image of the user is superimposed on top of the video image of the IM buddy). The audio window 1002 includes a control bar for adjusting the sensitivity of the microphone and a control bar for adjusting the volume.

Various well known video compression codecs may be employed on the system to encode/decode video. These include, but are not limited to the MPEG-2 (or “Motion Picture Experts Group-2”), MPEG-4, Real Video 8, and Audio Video Interleaved (“AVI”) to name a few. Of course, various different standard and proprietary audio/video compression codecs may be used while still complying with the underlying principles of the invention. In one embodiment, these codecs are implemented in software on the computer on which the IM client 200 is executed (e.g., a computer equipped with a general purpose processor such as a Pentium 4 or an Athlon 64). Alternatively, these codecs may be implemented by hardware such as a USB video capture device (e.g., a Webcam), or on a video capture card inserted in within a bus of the personal computer (e.g., a PCI bus).

Unlike any current IM clients, the IM client illustrated in FIG. 10 includes a full set of controls 1010-1014 for performing various personal video recorder (“PVR”) functions. The PVR functions include, but are not limited to, those performed by current personal video recorders such as Tivo or Replay TV. For example, in one embodiment, the IM video window includes a pause button 1010 for pausing the video and audio feed of the local user and/or the user's buddy. When the pause button is selected, the IM client freezes the current image(s) within the video window 1001, and begins storing the real time audio/video streams in memory (e.g., in RAM or to the local hard drive). When the pause button is deselected, the IM client 200 starts the video playback from the point in time at which the pause button was selected (i.e., reading and decoding the audio/video buffered in memory). The user may then fast-forward through the buffered audio/video to return to the real time audio/video session.

In addition, in one embodiment, during any audio/video session, the IM client automatically buffers a specified amount of audio and video (e.g., 20 seconds, 10 minutes, 20 Mbytes, . . . etc). As such, the user may rewind to a previous point in the audio/video and review the audio/video session from that point forward. As illustrated in FIG. 10, a review bar 1013 is provided for rewinding and fast-forwarding to different points within the stored audio/video session. In operation, the user may mouse-click on and drag the review bar 1013 to the left to rewind and to the right to fast-forward. A rewind button 1012 and a fast-forward button 1014 are also provided to allow the user to move backwards and forwards, respectively, through the stored audio/video. These buttons may be configured to jump a designated amount of time backward or forward within the audio/video, respectively.

In addition, one embodiment of the video window includes a “snap picture” button 1016 for snapping a still picture from the live or recorded video stream. In response, a still picture is automatically captured and stored within a designated folder on the IM client's computer.

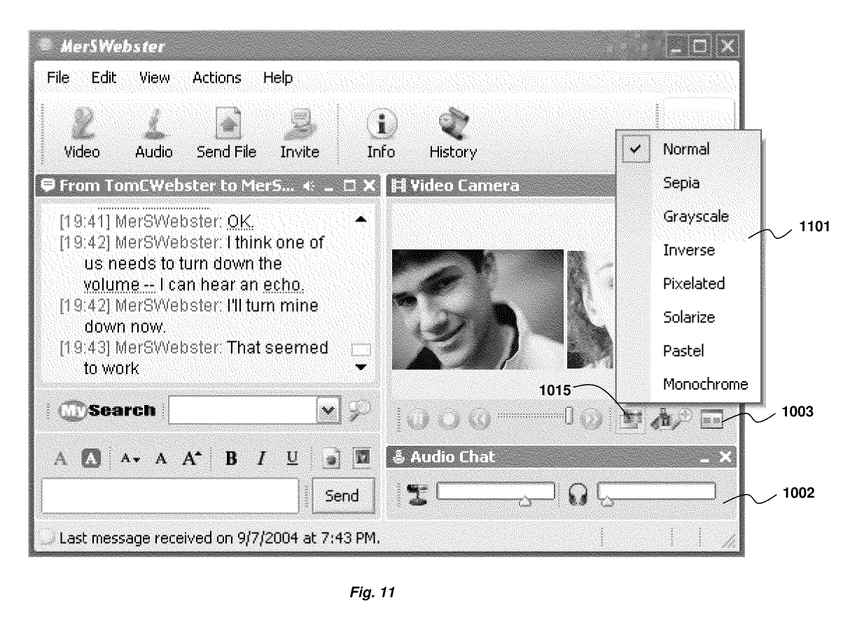

In one embodiment, an image adjustment button 1015 is also provided to allow the user to adjust various characteristics of the video image. Referring to FIG. 11, upon selection of the image adjustment button 1015, a menu of options 1101 is generated from which the user may select to adjust the image characteristics. In the particular example shown in FIG. 11, the choices on the image adjustment button include normal, sepia, grayscale, inverse, pixilated, solarize, pastel and monochrome. The functions performed by each of these image adjustment options are well known. Briefly, grayscale strips chrominance from the video image (color) and leave luminance (lighting properties), thereby creating a black-and-white image that properly represents lighting and shades. Sepia is equivalent to grayscale but with shades of brown, instead of black-and-white. Inverse inverts each pixel within an RGB triplet. For example, a pixel of RGB values 255,0,0 becomes 0,255,255. Pixilate generates an image in which each pixel equals the average of it's surrounding pixels, thereby creating a blurred effect. Solarize is similar to inverse, but only some RGB values are inverted. Pastel causes each pixel (RGB triplet) to be bound within a smaller subset of colors (e.g., instead of using 16 million colors, use ˜200 colors and find the closest match of original pixel, referred to as a “bounded set”). Monochrome strips chrominance and bounds luminance to two values (on or off), resulting in an exact black & white image with no shades of grey.

Certain image adjustment options may be useful in certain circumstances. For example, the “pixilate” feature may be used to blur the image of the user, thereby protecting the user's privacy. Various additional image adjustment options may be included within the list 1101 consistent with the underlying principles of the invention.

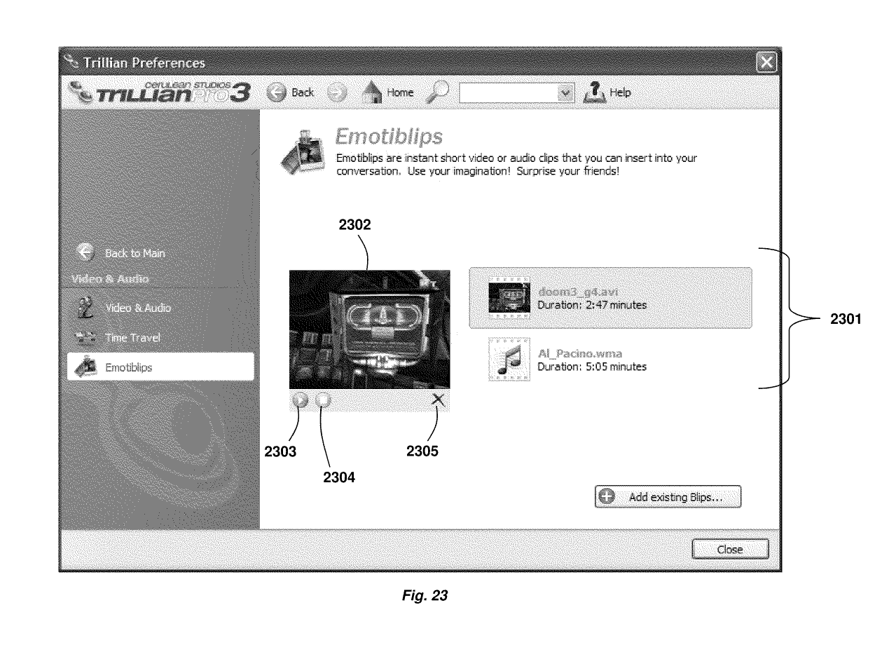

One embodiment of the invention allows users to permanently store audio/video clips (captured using the PVR features described above) and transmit the stored audio/video clips to IM contacts during IM sessions. Once a particular audio/video clip (referred to herein as an “emotiblip”) is permanently stored to the user's hard drive, the user may stream the audio/video clip to other IM contacts directly via the IM client 200. An exemplary GUI for managing emotiblips illustrated in FIG. 23 includes a listing 2301 of all emotiblips associated with the IM client. Each entry within the list includes the name of the emotiblip, the duration of the emotiblip, and the initial image in the video sequence. The GUI also includes a preview window/region 2302 for previewing installed emotiblips. The preview window includes a play button 2303, a stop button 2304 and a delete button 2305 (for removing the emotiblip from the system).

In one embodiment, during an IM session, if the user clicks a designated button in the video window toolbar, a menu is generated which includes a listing of all of the installed emotiblips. The user may then select an emotiblip from within the list to stream the emotiblip to another user. In one embodiment, the user may associate each emotiblip with a particular character sequence. For example, just as an emoticon translates the well known sequence “:)” into a graphical smiley face, another designated character sequence streams an emotiblip linked to the character sequence to the IM contact with whom the user is communicating. For example, the character sequence “:-0” might be linked to an emotiblip of a person screaming obscenities. A different character sequence might be linked to an audio file of a romantic message. A virtually unlimited number of emotiblips may be linked to character sequences in this manner.

In one embodiment of the invention, the audio/video windows employed within the audio/video IM session are highly configurable. First, both the video window and the audio window may be resized by the end user (e.g., by selecting the corner of the window and dragging using a mouse or other cursor control device). In addition, the audio and video windows (which are technically sub-windows or “sections” as described in the related applications) may be moved anywhere within the primary GUI window. In one embodiment, when one window within the GUI is moved, the other windows automatically adjust themselves to fit the new position of the window.

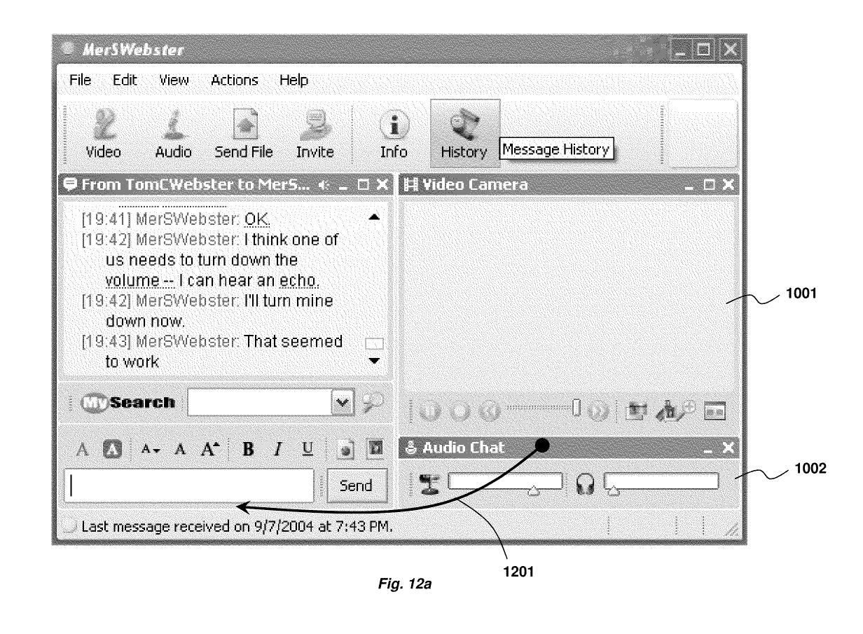

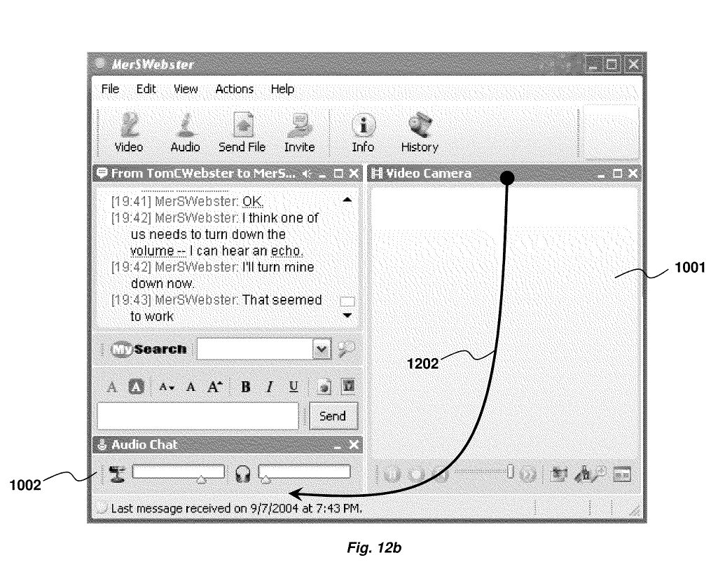

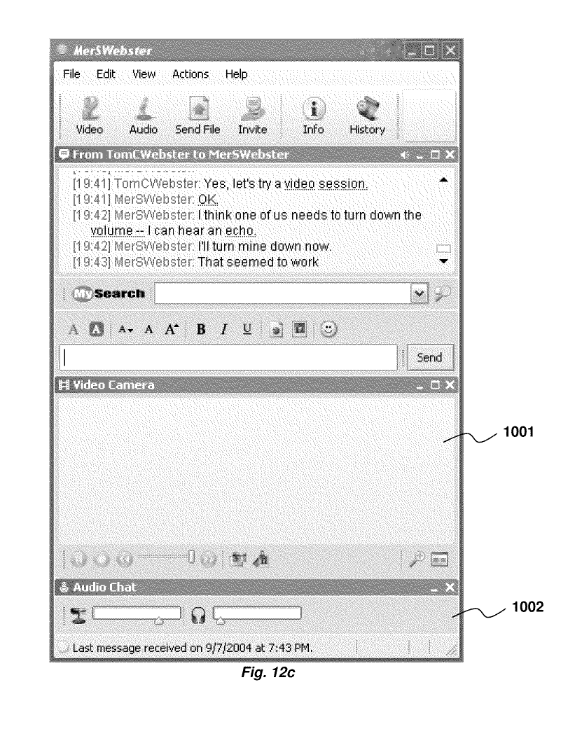

By way of example, when the audio window 1002 shown in FIG. 12a is moved as indicated by arrow 1201, the windows within the IM client automatically readjust themselves to fit the audio window 1002 in its new position beneath the search window, as indicated in FIG. 12b. Similarly, when the video window 1001 illustrated in FIG. 12b is moved beneath the audio window 1002, as indicated by motion arrow 1202, the windows within the IM client automatically readjust themselves to fit the video window 1001 in its new position, as indicated in FIG. 12c.

### Activity History Management

Current IM clients are typically only capable of simple text logging to preserve the history of instant messaging sessions (i.e., storing the text of each instant messaging session within a log file). By contrast, one embodiment of the invention captures a complete history of user activity during each IM session as well as an intuitive GUI for displaying the activity history.

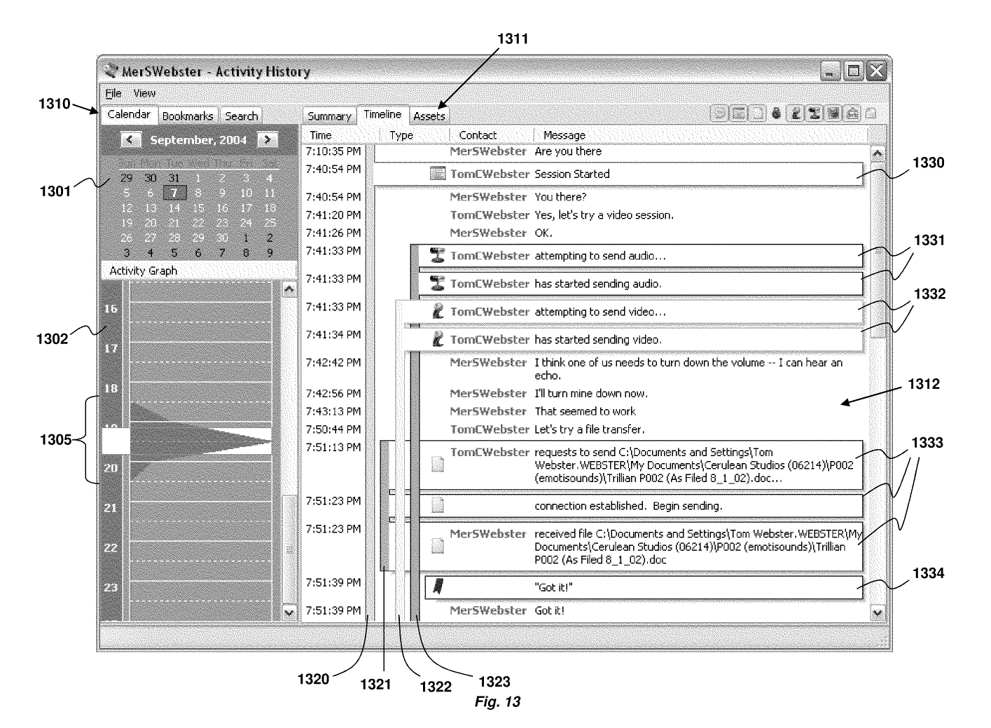

FIG. 13 illustrates one embodiment of an activity history interface for displaying the activity history of IM sessions for a particular contact (or group of contacts). In one embodiment, the activity history GUI is generated by selecting a particular contact from the user's buddy list, right clicking to generate a list of options, and selecting “activity history” option from within the menu. The activity history GUI shown in FIG. 13 includes a first set of tabs 1310 and a second set of tabs 1311. A calendar tab is selected from within the first set, thereby revealing a monthly calendar 1301 and an “activity graph” 1302, and a “timeline” tab is selected from the second set, thereby generating a timeline window 1312 containing a sequential representation of IM activity.

To view IM activity for a particular date, the user selects the date from within the calendar 1301 (e.g., Sep. 7, 2004 is selected in the example). As a result, a sequential list of IM activity which occurred on that date is generated within the timeline window 1312. Each element within the timeline window 1312 is provided with unique graphical features to identify the type of activity which the element represents. In addition, to further differentiate each element, a series of color-coded graphical bars 1320-1323 which run the length of the timeline are graphically coupled to each of the elements as shown (except for text elements and bookmarks, which are not associated with a graphical bar). For example, a first graphical bar 1320 of a first color is graphically coupled to a session start element 1330 and a session end element which indicates the start and end of the IM session, respectively (the session end element is not visible in FIG. 13). In addition, the session start and end elements include unique icons to further identify the start and end of the IM session. A second graphical bar 1321 of a second color is graphically coupled to file transfer elements 1333 which indicate the occurrence of a file transfer during the IM session. The file transfer elements 1330 also include unique icons to further differentiate the file transfer elements. A third graphical bar 1322 of a third color is graphically coupled to video session start/stop elements 1332 which indicate the occurrence of a video session and a fourth graphical bar 1323 of a fourth color is graphically coupled to audio session start/stop elements 1331 which indicate the occurrence of an audio session. The audio/video elements each include unique icons to identify the audio/video portion of the session. Using color-coded graphical elements and icons in this manner simplifies the review of complex IM activity. Note that in the illustrated example, the audio and video session overlap (as indicated by concurrent, parallel audio and video graphical bars).

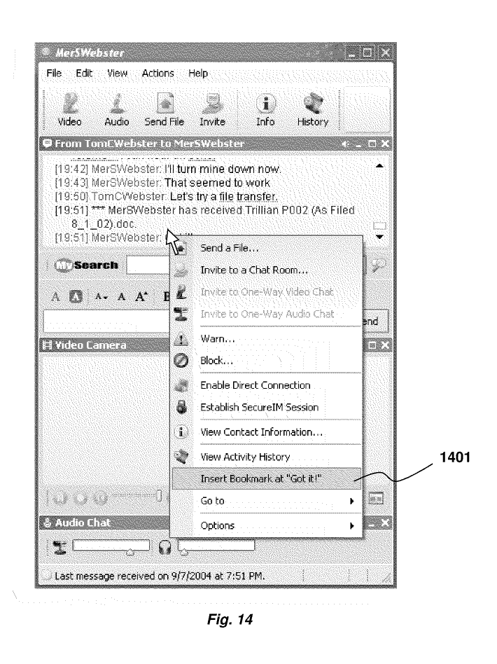

A bookmark element 1334 is also illustrated towards the bottom of the timeline in FIG. 13, indicating that the user inserted a bookmark at that point during the IM session. As illustrated in FIG. 14, in one embodiment, the user may enter a bookmark by right clicking on the text within the IM chat window to generate a menu 1401, and selecting “insert bookmark at [text]” from within the menu (where [text] represents the text of the IM chat where the bookmark is entered). Of course, the particular manner in which the bookmark is inserted is not relevant to the underlying principles of the invention.

The activity graph 1302 shown in FIG. 13 displays a graph of the total level of activity during the IM session. In this particular example, IM activity occurred between approximately 18:30 (6:30 PM) and 20:30 (8:30 PM) and peaked at approximately 19:30. In one embodiment, multiple graphs may be included within the activity graph to represent the level of multiple types of activity (e.g., a separate graph for video, audio, text, file transfers, . . . etc).

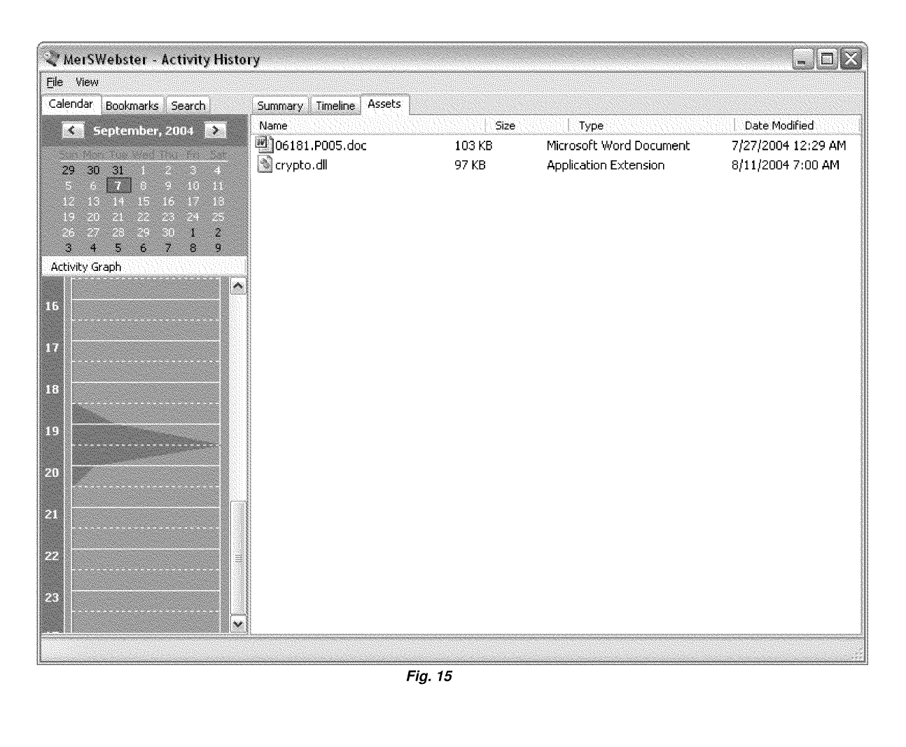

An “assets” tab is included within the second set of tabs 1311. As illustrated in FIG. 15, selecting the assets tab generates a list of all content employed during between the user and the IM contact associated with the activity history window during IM sessions. The types of content stored under the assets tab includes, but is not limited to, files transferred, buddy icons, video and audio sessions, etc. For example, if a user records audio and/or video from an IM session, the audio/video file will appear within the assets tab. In the specific example shown in FIG. 15, a Microsoft Word document and a dynamic link library (.dll) file have been transferred between the user and the contact. In one embodiment, the IM client 200 stores each file in a designated temporary storage folder until moved to an alternate folder by the end user.

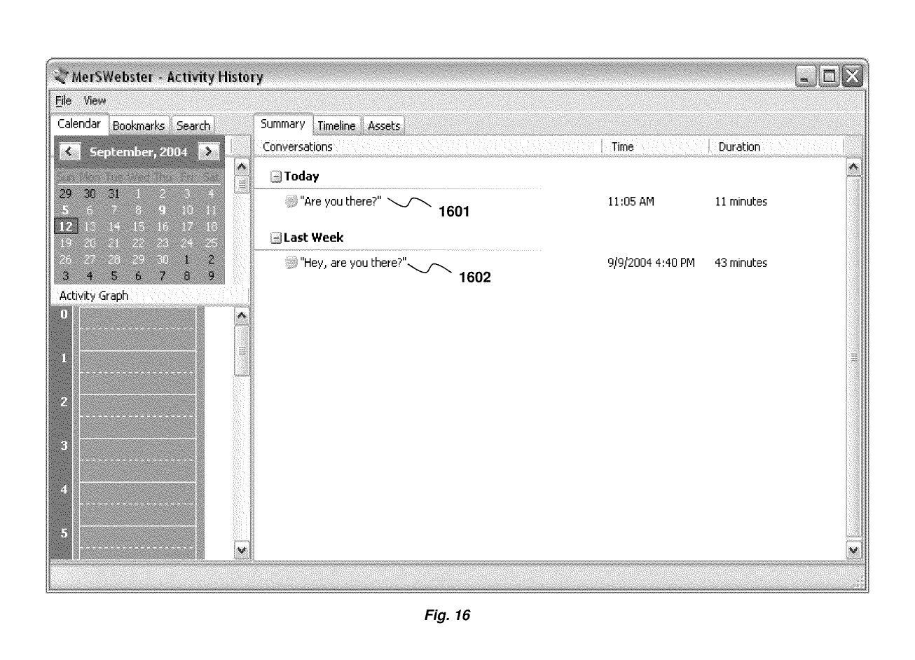

A “summary” tab is also included within the second set of tabs 1311. As illustrated in FIG. 16, the summary tab provides a short summary of each instant messaging session between the user and a particular IM contact. In FIG. 16, the summary is simply the first IM text entered by one of the users participating in the session. However, various alternate summary formats may be used (e.g., the initial text followed by the initial response). In one embodiment, clicking on the summary entry causes the complete timeline associated with that entry to appear under the “timeline” tab.

A “bookmarks” tab, included within the first set of tabs 1310, contains a comprehensive list of all bookmarks generated by the user. FIG. 16 illustrates an example with two bookmarks comprising a bookmark icon, followed by the text after which the bookmark was entered. By selecting a particular bookmark, the user may jump to the point where the bookmark was entered within the timeline.

A “search” tab included within the first set of tabs 1310, contains a variety of options for searching the activity of stored instant messaging sessions. First, a data entry field 1800 is provided in which the user may enter one or more text strings. The stings may be combined using various logical operators (e.g., AND, OR, NOT, . . . etc).

An options menu is also provided for entering more advanced search options by selecting from a series of check boxes. The options include a date option 1801 to search within a specified date range, via drop down selection menus as shown. Preset date options may also be selected (via circular selection elements), as illustrated (e.g., within the past week, month, year, etc).

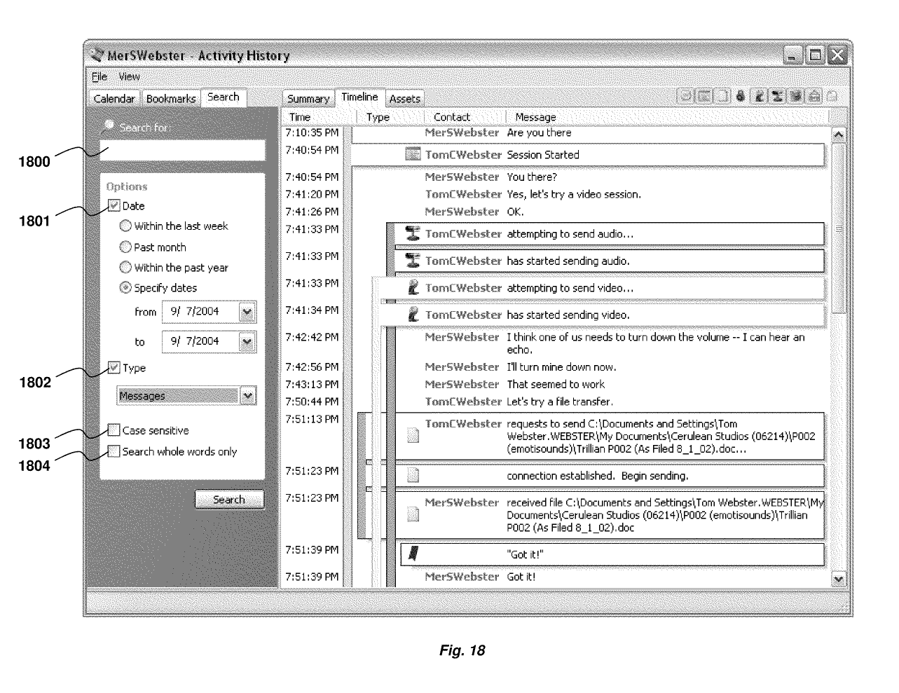

In addition, a “type” option 1802 is provided to allow searching for specific types of activity. In the embodiment illustrated in FIG. 18, different types may be selected via a drop down menu. The activity types include, but are not limited to, audio, file transfers, icon changes, messages, secure messages, sessions, status, typing and video. Option 1803 may be selected to search for the entered text in a case sensitive manner and/or option 1804 may be selected to search for whole words only.

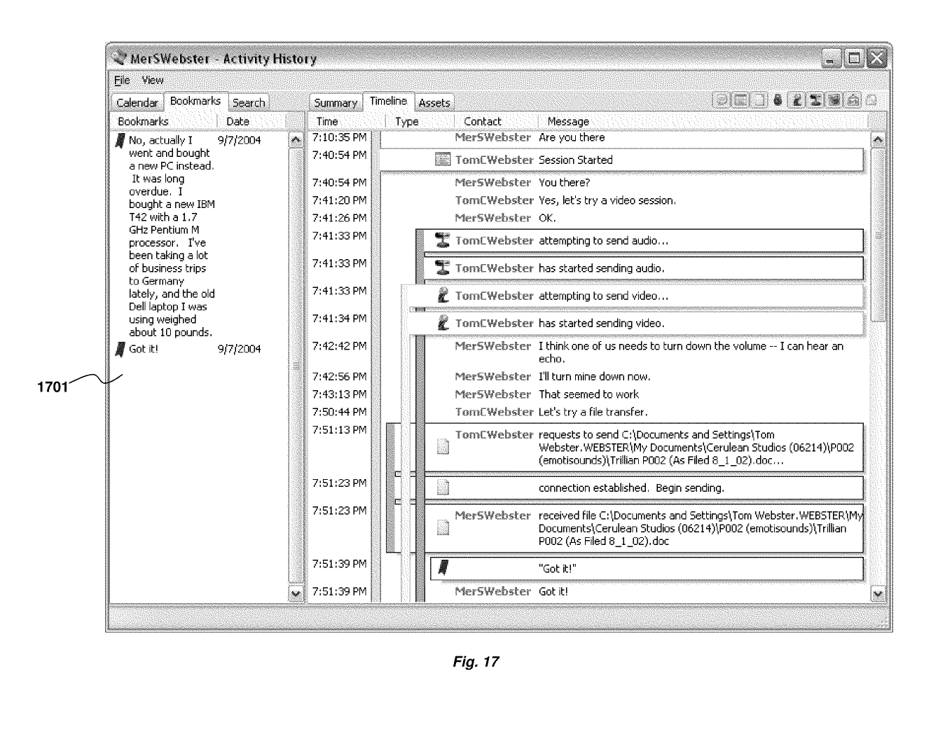

In one embodiment, the various types of activity history illustrated in FIGS. 13-18 is stored in an extensible markup language (“XML”) format (e.g., according to a specified XML format or schema). As such, any application provided with an understanding of how the XML file is formatted can interpret and process the data contained within the XML file.

A separate activity history such as that illustrated in FIGS. 13-18 may be maintained for each contact, or for designated contact groups with whom the user communicates.

### Plugin User Interface

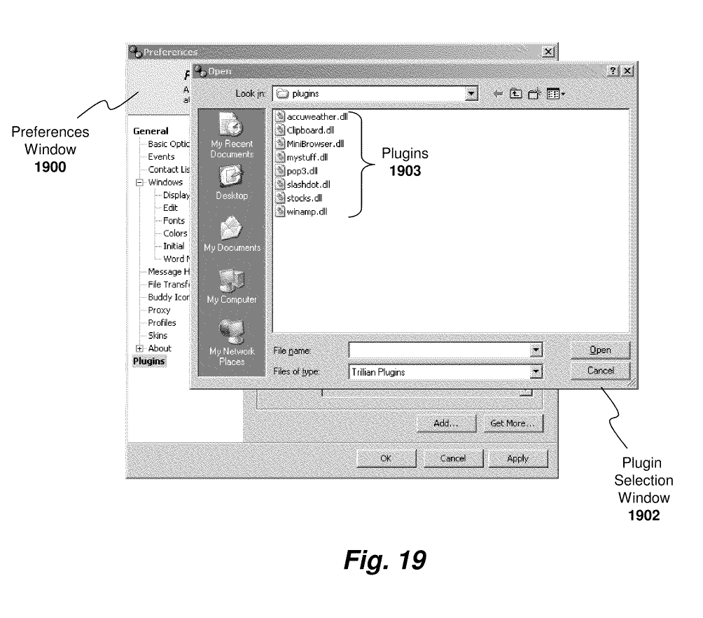

One embodiment of the invention provides an application programming interface for plugins—i.e., supplemental programs which provide the primary IM client 200 with additional features. Referring to FIG. 19, in the embodiments described in the related applications, plugins 1903 could be installed and activated via a plugin selection window 1902, generated by selecting the “plugins” option from the IM client's preferences window 1900. Once the plugin selection window 1902 was opened, the user could install a plugin by selecting an appropriate dynamic link library (.dll) file from the selection window 1902.

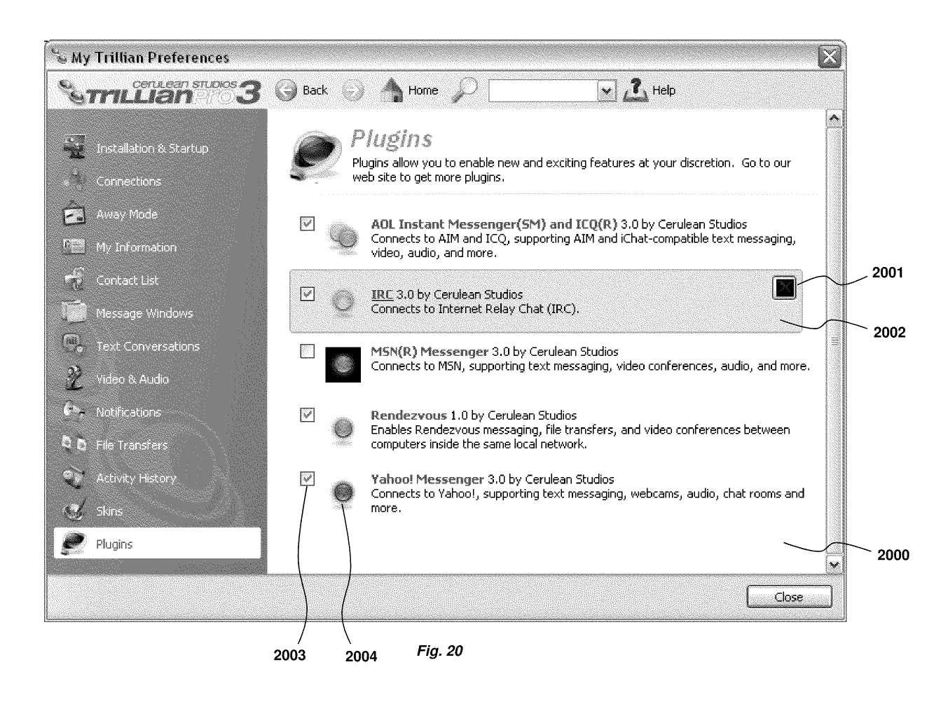

By contrast, one embodiment of the present invention provides a more intuitive graphical user interface for adding, activating/deactivating and removing plugins. Referring to FIG. 20, this embodiment includes a plugin GUI which includes a list of plugins 2000 from which the user may select. The list is generated automatically when the plugin GUI is initiated and includes any plugins (e.g., any .dll files) located within a specified /plugin directory. Unlike prior IM clients, each plugin entry in the list includes the title and version of the plugin, the plugin author, and a brief description of the plugin. A particular entry may be selected via a mouse or other cursor control device. In the example shown in FIG. 20, entry 1902 has been selected. A deletion button 2001 is provided for each selected plugin entry. Selecting the deletion button 2001 completely removes the plugin from the IM client, including all configuration data associated with the plugin. By contrast, each plugin entry also includes a deactivation check box 2003. Selecting the deactivation check box for a plugin disables the plugin but does not completely remove the plugin from the IM client.

Both the deletion button and the deactivation button will remove the plugin from the runtime environment of the IM client. However, if the plugin is merely deactivated, the plugin program code and configuration data will be retained on the user's hard drive. As such, if the user later chooses to reactivates the plugin, the user will not be required to reconfigure the plugin from scratch. The plugin configuration data may include user preferences such as account and connection data, away messages, news topics, email addresses, . . . etc.

When a plugin is deleted via the deletion button 2001, it is completely removed from the list and the IM client. By contrast, when a plugin is deactivated, it is retained in the list but the icon associated with the plugin is grayed out, as illustrated in FIG. 20 (and the check box associated with the plugin is unchecked). The program code associated with the plugin is also retained.

In one embodiment of the invention, each sub-window or “section” within the primary IM window is provided by a separate plugin. For example, the video window 1001 and audio window 1002 illustrated in FIG. 10 may be separate plugins within the IM client 200. In addition, in one embodiment, support for each IM service (e.g., AIM, Yahoo) is enabled by a separate plugin. As described in the related applications, various additional plugins may be added to the system including, for example, news plugins, Web server plugins, music plugins, email plugins, . . . etc.

### Smartgroups and Tabbed Container Windows

In a typical IM client, groups may be created to categorize instant messaging buddies. For example, a typical instant messaging group might be named “Friends” or “Co-Workers,” and contain a list of IM identities.

In one embodiment of the invention, IM groups, referred to herein as “smartgroups” are dynamically generated based on IM usage. For example, in one embodiment, the top N contacts with whom the user conducts IM sessions most frequently are automatically placed within a “Top N Friends” group or a “Friends I've Chatted With Most” group. By contrast, the contacts with whom the user seldom communicates are placed within a “Friends I've Chatted With Least” group.

In one embodiment, the “Friends I've Chatted With Most” and “Friends I've Chatted With Least” groups are not merely generated based on the raw number of IM sessions conducted with each contact. Rather, in one embodiment, the amount of time spent during each IM session and/or the amount of text or other content transmitted during each IM session may be factored into the determination. For example, a user may only establish an IM session with a particular contact once every few days, but may spend several hours with the contact during each IM session (thereby indicating that the contact should be considered a “Top N Friend.”

Various additional smartgroups groups may be generated based on a statistical analysis of IM usage while still complying with the underlying principles of the invention. For example, in one embodiment, a “Top N Video Contacts” group is dynamically generated to include those contacts with whom the user most frequently establishes video sessions. Moreover, in one embodiment, smartgroup functionality is employed within other IM sections such as the “news” section. For example, a “News Items From 10 Minutes Ago” group may be configured to store headlines of only the most recent news items.

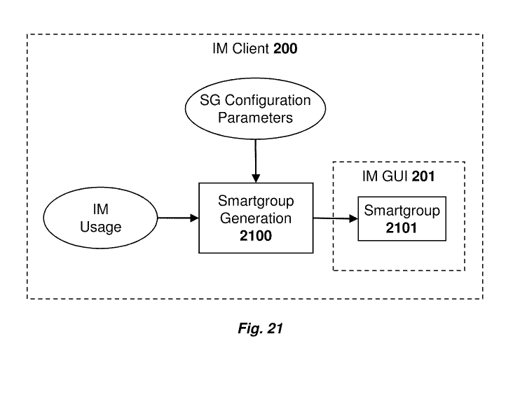

FIG. 21 illustrates one embodiment of an architecture for implementing the foregoing smartgroup functions. This embodiment includes a smartgroup generation module 2100 which analyzes certain statistical aspects of IM usage and, in response, generates one or more smartgroups 2101 within the IM GUI 201. The smartgroup generation module 2100 may be programmed to generate smartgroups according to a variety of smartgroup configuration parameters such as, for example, how often a user establishes an IM session with each contact, how long the user spends in IM sessions with each contact, how much content is transmitted the IM sessions, . . . etc. A default set of configuration parameters may initially be provided within the IM client 200. In one embodiment, the end user may modify the default parameters and/or add new parameters based on the user's preferences.

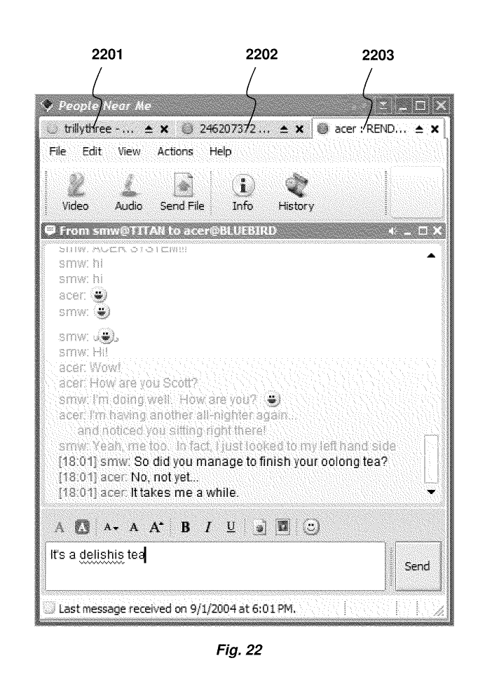

FIG. 22 illustrates one embodiment of a contacts IM window which employs a series of tabs 2201-2203 to manage contact groups (such as the smartgroups described above). In this embodiment, when a user starts an IM session with one or more contacts from a particular group, tabs 2201-2203 are automatically generated within the GUI 201 for each contact within the group (or, in one embodiment, each contact who is online). The user may then send/receive instant messages to/from each contact, by selecting the appropriate tab (as opposed to managing a separate IM window for each individual contact within the group).

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while the embodiments of the invention described above focus on a specific graphical user interface implementation for the IM client, various alternate interface types may be employed including text-based interfaces. In addition, although a client-based implementation is described above, a server-based implementation (or other distributed computing implementation) is also contemplated within the scope of the present invention. Accordingly, the scope and spirit of the invention should be judged in terms of the claims which follow.

What is claimed is:

1. A computer-implemented method comprising:
analyzing text entered by one or more users during an instant messaging session;
determining a context in which words in the text are being used wherein determining a context for a current word comprises evaluating one or more other words used prior to or following the current word and identifying a correlation between the current word and the one or more other words which correspond to a particular context;
identifying supplemental content based on the context;
highlighting the text to indicate to a user that supplemental content associated with the text is available; and
providing the supplemental content to the user responsive to the user requesting the supplemental content.

2. The method as in claim 1 wherein determining a context comprises evaluating a correlation between two or more words in the text, the correlation revealing a particular context.

3. A system comprising:
a text analysis module to analyze text entered by one or more users during an instant messaging session;
a context determination module to determine the context in which words in the text are being used wherein determining a context for a current word comprises evaluating one or more other words used prior to or following the current word and identifying a correlation between the current word and the one or more other words which correspond to a particular context;
a supplemental content processing module to identify supplemental content based on the context;
an instant messaging graphical user interface (“IM GUI”) to highlight the text or portions thereof to indicate to a user that supplemental content associated with the text is available and display the supplemental content to the user responsive to the user requesting the supplemental content.

4. The system as in claim 3 wherein determining a context comprises evaluating a correlation between two or more words in the text, the correlation revealing a particular context.

5. A machine-readable medium having stored thereon program code which, when executed by a machine, cause the machine to perform the operations of:
analyzing text entered by one or more users during an instant messaging session;
determining a context in which words in the text are being used wherein determining a context for a current word comprises evaluating one or more other words used prior to or following the current word and identifying a correlation between the current word and the one or more other words which correspond to a particular context;
identifying supplemental content based on the context;
highlighting the text to indicate to a user that supplemental content associated with the text is available; and
providing the supplemental content to the user responsive to the user requesting the supplemental content.

6. The machine-readable medium as in claim 5 wherein determining a context comprises evaluating a correlation between two or more words in the text, the correlation revealing a particular context.

7. The method as in claim 1 wherein highlighting the text comprises underlining the text.

8. The method as in claim 1 wherein highlighting the text comprises highlighting the foreground of the text.

9. The method as in claim 1 wherein highlighting the text further comprises:
highlighting text having a first context using a first type of highlighting and highlighting text having a second context using a second type of highlighting.

10. The system as in claim 3 wherein highlighting the text comprises underlining the text.

11. The system as in claim 3 wherein highlighting the text comprises highlighting the foreground of the text.

12. The system as in claim 3 wherein highlighting the text further comprises:
highlighting text having a first context using a first type of highlighting and highlighting text having a second context using a second type of highlighting.

13. The machine-readable medium as in claim 5 wherein highlighting the text comprises underlining the text.

14. The machine-readable medium as in claim 5 wherein highlighting the text comprises highlighting the foreground of the text.

15. The machine-readable medium as in claim 5 wherein highlighting the text further comprises:
highlighting text having a first context using a first type of highlighting and highlighting text having a second context using a second type of highlighting.
